(19) United States
(12) Patent Application Publication
(10) Pub. No.: US 2011/0258033 A1
(43) Pub. Date: Oct. 20, 2011

(54) EFFECTIVE AD PLACEMENT

(75) Inventors: Sreenivas Gollapudi, Cupertino, CA (US); Rina Panigrahy, Sunnyvale, CA (US)

(73) Assignee: Microsoft Corporation, Redmond, WA (US)

(21) Appl. No.: 12/760,572

(22) Filed: Apr. 15, 2010

(51) Int. Cl. G06Q 30/00; G06F 17/30

(52) U.S. Cl. 705/14.42; 707/726; 705/14.43

(57) ABSTRACT

Search results and ads that satisfy a query may be formatted into a search results page where an initial placement of ads may result in an estimated click through rate for the presented ads. An adjustment factor may be determined based on parameters associated with the search results, such as the clicks on the search results themselves. The adjustment factor may be applied to a particular ad to determine if an estimated click through rate of the particular ad will change with respect to a position when there are a first number of mainline ads and a second number of side bar ads. Mainline exclusivity may be appropriate for an ad to increase the click through rate of the ad. The increase may be determined in accordance with the adjustment factor to decide whether to present the ad with mainline exclusivity.

### BACKGROUND

Search engines typically are the starting point from which users begin their browsing for goods and services. The sponsored search ads are a major source of revenue for the search engine provider. Several parameters come into play when displaying ads. These may include the number of ads to be shown, the placement of the ads, and the specific choice of ad for each location. For example, ads may be shown in the “mainline” position above the search results or in the “side bar” so as not to overwhelm the user with too many ads. Search engines often restrict the number of ads in each of these locations (for example, three mainline ads and five side bar ads may be shown).

Click logs may provide information that can be used to infer several parameters related to the relevance of search results and placement of ads in response to queries. However, often there far fewer clicks on ads as compared to search results. Thus, while the click logs can be used to study parameters related to search results, the sparseness of the number of clicks for ads renders it is difficult to infer meaning to parameters related to ads.

### SUMMARY

In general, one aspect of the subject matter can be implemented in a method for determining whether an ad may be afforded mainline exclusivity in a search results page. The placement of ads may affect the estimated click through rate of the ads in the search results page. In some implementations, mainline exclusivity may be appropriate for an ad to increase the click through rate of the ad, while in others it might have a negative impact on the click through rate on the ad. In order to determine when to turn on exclusivity, the change in click through rates with and without exclusivity may be estimated. Determining this change may be based on click information associated with the ads determined using parameters associated with search results, as there is often more click information associated with search results than the ads. The click information may be encapsulated as an adjustment factor.

In accordance with some implementations, a method is provided that includes determining a first placement of ads a search results page. The search results page may include search results that are responsive to a query. An adjustment factor may be determined based on parameters associated with the search results and applied to the first placement of ads to determine if a second placement of ads results in a higher estimated click through rate for an ad.

In accordance with some implementations, a method includes determining search results that satisfy a query, where the search results may be formatted into a search results page. A placement of ads to be served in the search results page may be determined, as well as an estimated click through rate of the ads in the search results page. An adjustment factor may be determined based on parameters associated with the search results, where the adjustment factor may be applied to an ad to determine a click through rate of the ad at a position when there are a first number of mainline ads and a second number of side bar ads. The ad may be present having mainline exclusivity if the click through rate determined in accordance with the adjustment factor is higher than the estimated click through rate.

This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of illustrative embodiments, is better understood when read in conjunction with the appended drawings. For the purpose of illustrating the embodiments, there are shown in the drawings example constructions of the embodiments; however, the embodiments are not limited to the specific methods and instrumentalities disclosed. In the drawings:

FIG. 1 is a block diagram of an example online environment;

FIG. 2 is a block diagram of an example ad placement subsystem;

FIG. 3 illustrates example relative placement of ads on a search results page;

FIG. 4 illustrates an operational flow of an implementation of a method for determining if mainline exclusivity (MLE) may be applied to an ad presented as a result of a query;

FIG. 5 illustrates an operational flow of an implementation of a method to determine an estimate of a position bias adjustment factor from known parameters associated with a query;

FIGS. 6 and 7 illustrate various plots showing the gain in click through rate (CTR) when mainline exclusivity (MLE) is activated for a particular query; and

FIG. 8 shows an exemplary computing environment.

### DETAILED DESCRIPTION

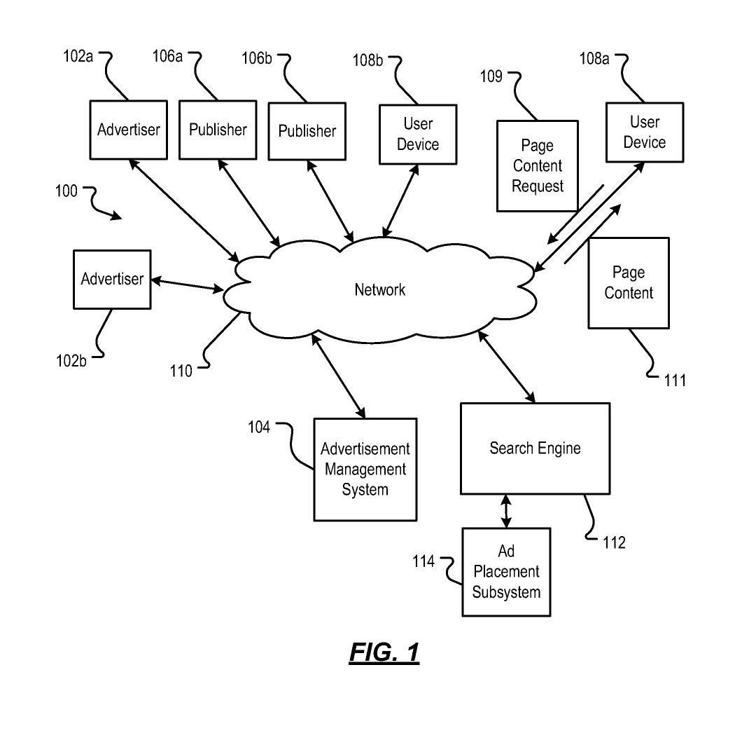

FIG. 1 is a block diagram of an example online environment 100. The online environment 100 may facilitate the identification and serving of content items, e.g., web pages, advertisements, etc., to users. A computer network 110, such as a local area network (LAN), wide area network (WAN), the Internet, or a combination thereof, connects advertisers 102a and 102b, an advertisement management system 104, publishers 106a and 106b, user devices 108a and 108b, a search engine 112, and an ad placement subsystem 114. Although only two advertisers (102a and 102b), two publishers (106a and 106b), and two user devices (108a and 108b) are shown, the online environment 100 may include many thousands of advertisers, publishers, and user devices.

In some implementations, one or more advertisers 102a and/or 102b may directly or indirectly enter, maintain, and track advertisement information in the advertising management system 104. The advertisements may be in the form of graphical advertisements, such as banner advertisements, text only advertisements, image advertisements, audio advertisements, video advertisements, advertisements combining one of more of any of such components, etc., or any other type of electronic advertisement document.

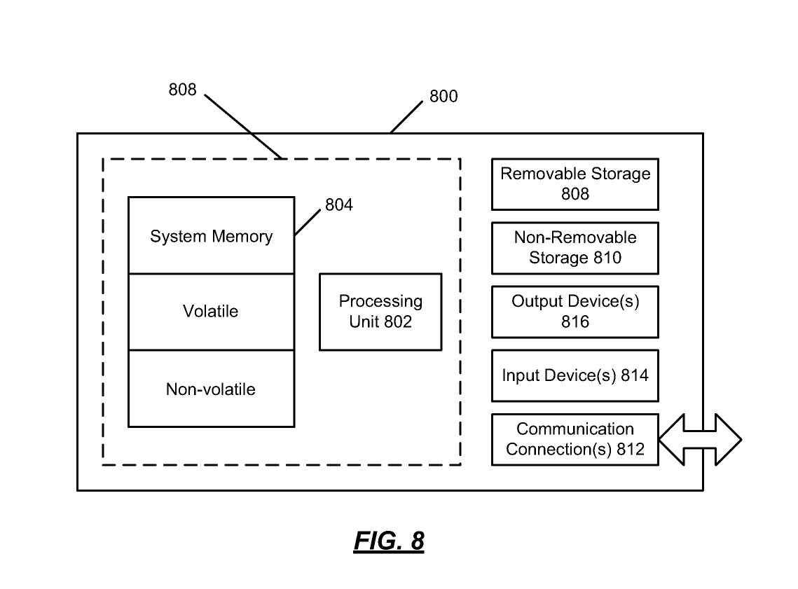

A user device, such as user device 108a, may submit a page content request 109 to a publisher or the search engine 112 using a web browser application running on the user device 108a. In some implementations, the page content 111 may be provided to a web browser running on the user device 108a in response to the request 109. The page content may include advertisements provided by the advertisement management system 104. Example user devices include personal computers (PCs), mobile communication devices, television set-top boxes, etc. An example user device is described in more detail below with reference to FIG. 8.

Advertisements may also be provided from the publishers. For example, one or more publishers 106a and/or 106b may submit advertisement requests for one or more advertisements to the system 104. The system 104 responds by sending the advertisements to the requesting publisher 106a or 106b for placement on one or more of the publisher's web properties (e.g., websites and other network-distributed content).

Advertisements may also be provided through the use of the search engine 112. The search engine 112 may receive queries for search results. In response, the search engine 112 may retrieve relevant search results from an index of documents (e.g., from an index of web pages). Search results may include, for example, lists of web page titles, snippets of text extracted from those web pages, and hypertext links to those web pages, and may be grouped into a predetermined number (e.g., ten, twenty, etc.) of search results.

The search engine 112 may also submit a request for advertisements to the system 104. The request may include a number of advertisements desired. This number may depend on the search results, the amount of screen or page space occupied by the search results, the size and shape of the advertisements, etc. The request for advertisements may also include the query (as entered or parsed), information based on the query (such as geo-location information, whether the query came from an affiliate and an identifier of such an affiliate), and/or information associated with, or based on, the search results. Such information may include, for example, identifiers related to the search results (e.g., document identifiers or “docIDs”), scores related to the search results (e.g., information retrieval (“IR”) scores), snippets of text extracted from identified documents (e.g., web pages), full text of identified documents, feature vectors of identified documents, etc. In some implementations, IR scores may be computed from, for example, dot products of feature vectors corresponding to a query and a document, page rank scores, and/or combinations of IR scores and page rank scores, etc.

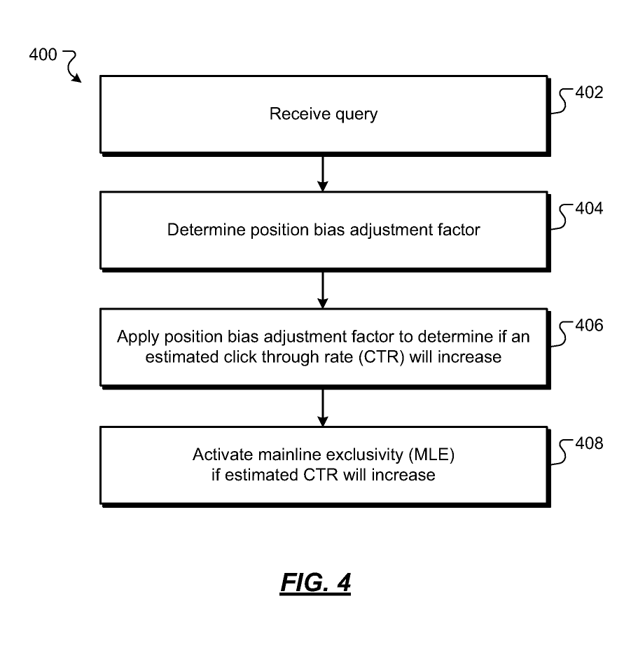

The search engine 112 may combine the search results with one or more of the advertisements provided by the system 104. A positioning and number of advertisements combined with the search results may be determined by the ad placement subsystem 114. This combined information may then be forwarded to the user device 108a that requested the content as the page content 111 to be displayed in the web browser running on the user device 108a. The search results may be maintained as distinct from the advertisements, so as not to confuse the user between paid advertisements and presumably neutral search results (see, e.g., FIG. 4).

In accordance with implementations herein, the ad placement subsystem 114 may determine for each query, an estimated click through rate of the advertisements presented with the search results. The ad placement subsystem 114 may evaluate parameters of the search results to determine if a particular ad, when displayed alone, may have a higher estimated click through rate. If so, the particular ad may be afforded “mainline exclusivity” or MLE, i.e., presented alone above the search results in a mainline advertising position. Other positions/numbers of ads may be considered by the ad placement subsystem 114 to increase the click through rate.

The advertisers 102, user devices 108, and/or the search engine 112 may also provide usage information to the advertisement management system 104. This usage information may include measured or observed user behavior related to advertisements that have been served.

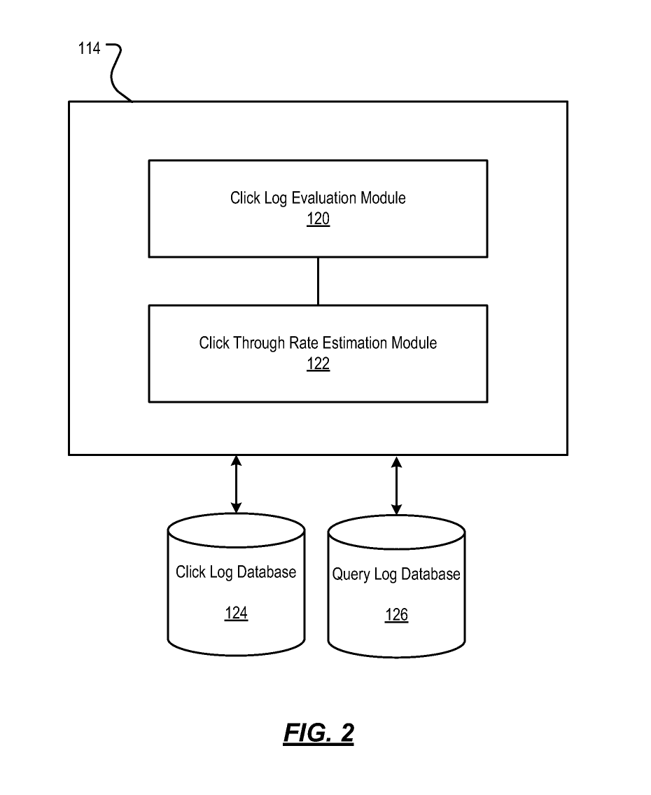

FIG. 2 is a block diagram of an example ad placement subsystem 114. The example ad placement subsystem 114 may include a click log evaluation module 120 and a click through rate estimation module 122. Additional details of the ad placement subsystem 114 are described below with reference to FIG. 8. In some implementations, the click log evaluation module 120 retrieves click data related to search results from a click log database 124. For example, the click log database 124 may contain data regarding clicks of the ordered search results provided in the page content 111, such as clicks of links provided as a first, second, etc., result.

The click log evaluation module 120 may extract information regarding clicked links at particular positions (e.g., a link presented as a first link in the ordered search results). The click log evaluation module 120 may also extract information regarding the links when they appear at different positions in the ordered search results. The extracted information may be provided to the click through rate estimation module 122, which may use this information and query frequency information stored in a query log database 126 to determine an estimated click through rate of an ad presented, e.g., having mainline exclusivity on the page content 111 or having other presentations.

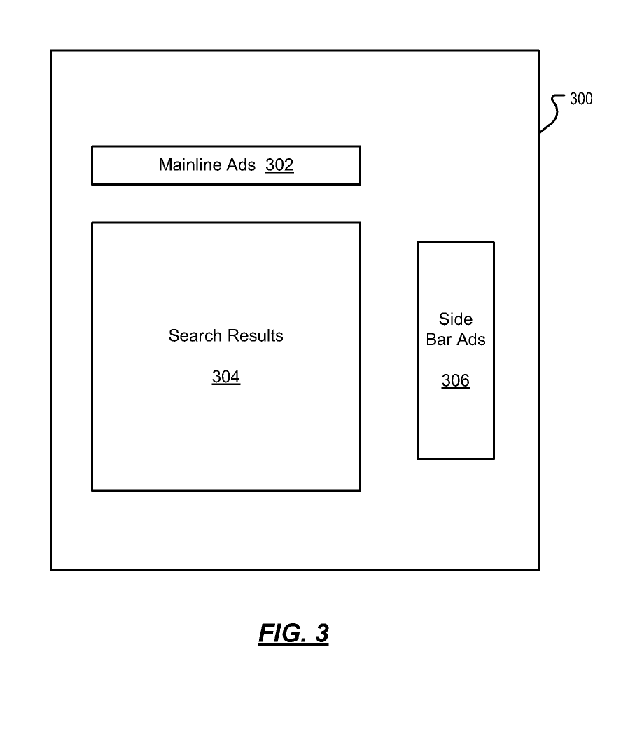

FIG. 3 illustrates example relative placement of ads on a search results page 300. The results page 300 may contain mainline ads 302, search results 304 and side bar ads 306. The search results 304 may be a ranking of results that satisfy a user query submitted to the search engine 112 and returned with the page content 111. The mainline ads 302 and side bar ads 306 may be ads that are presented based on the request for advertisements, as described above. The placement of the ads as mainline ads 302 or side bar ads 306 may be made based on factors such as a bidding process, exclusivity agreements, the user query, keywords, geographic location of the user device 108a, or any other factor utilized by the search engine 112 as part of ad placement.

The search engine 112 may have a preference for a maximum number of ads to be placed as either the mainline ads 302 or the side bar ads 306. The maximum number of ads may be determined based on any number of factors, including click through rate (CTR), economic return, a desire not to overwhelm a user, or as part of a predetermined results page design. However, for some queries it may be preferable to show fewer than the maximum number of ads. In some cases, showing fewer ads may result in an increased click through rate for the displayed ads versus when the maximum number of ads is displayed. This may lead to higher total revenue for the search engine 112. Thus, in accordance with implementations herein, determining the number of ads to be shown may include an analysis of the effects of the number of ads and the position of ads on the click through rate. Further, these effects may not be the same for every query, which means that they may be applied on a per query basis.

FIG. 4 illustrates an operational flow of an implementation of a method 400 for determining if mainline exclusivity may be applied to an ad presented as a result of a query. Generally, MLE may be applied by estimating click through rates of ads in accordance with a total number and/or a position of a particular ad with respect to a received query. Other factors may be used to estimate other types of ad parameters. If an estimated click through rate increases as a result of MLE for the particular ad, then MLE may be activated for a results page 300 communicated to a user device 108a.

At 402, a query is received. For example, a query may be received by the search engine 112 from the user device 108a. At 404, a position bias adjustment factor is determined. To decide a number of ads that may be shown for a set of search results, an estimate of the click through rate of ads at different positions and with different total number of ads may be determined. The position bias adjustment factor, p_{q,i,m,n}, may be used, which is an adjustment factor applied to obtain the CTR of an ad served for a query “q” at position “i,” when there are “m” mainline ads and “n” side bar ads.

If CTR_{a,q,i,m,n} denotes the CTR of an ad “a” for query “q” at position “i” with “m” mainline and “n” side bar ads, then if an argument is omitted, the resulting CTR will be an aggregated (e.g., averaged) value over that argument. For example, CTR_{q,i,m,n} represents an aggregate CTR over all ads for the query “q” at position “i” with “m” mainline and “n” side bar ads.

The adjustment factor p_{q,i,m,n} (that is modeled to be independent of the ad) is a measure the ratio:

p_{—}{q,i,m,n}=CTR_{—}{a,q,i,m,n}/CTR_{—}{a,q,1,3,5} (1).

While the adjustment factor may be determined as an estimate of CTR_{a,q,i,m,n} and CTR_{a,q,1,3,5}, as noted in Equation (1), click logs often have very few clicks in the ad positions. Thus, the click logs may not be useful for obtaining accurate estimates of CTR_{a,q,i,m,n}. Although the values 1, 3, and 5 are used for “i”, “m”, and “n” respectively, in the example of Equation (1), any values may be used depending on the implementation.

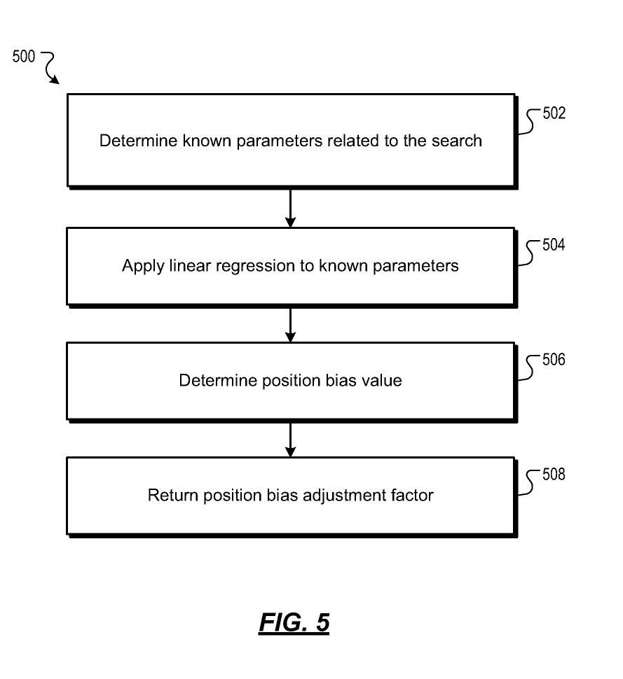

FIG. 5 illustrates an operation flow of an implementation of a method 500 to determine an estimate of the position bias adjustment factor that is determined at 404 from known parameters associated with a query. With reference to FIG. 5, at 502, the known parameters related to the search are determined. In accordance with some implementations herein, click data associated with the search results (i.e., a known parameter) may be used to learn the adjustment factor p_{q,i,m,n}. In particular, the search results often receive more clicks than ads, and the search result-related clicks may be used to infer the adjustment parameter p_{q,i,m,n} for the ad positions, where the adjusted ad positions may include unknown parameters.

For example, in some implementations, a main line exclusivity decision process may be performed to determine if presenting one mainline ad, rather of a typical number of ads, such as three, five, or other number for example, will increase the CTR for the presented single ad. However, for a particular query, it may not be known how the CTR changes when one mainline ad is presented instead of more than one ad (i.e., the three, five, or other number of ads). Thus, the search parameters for one mainline ad would be unknown. To determine the unknown parameters, operations 504 and 506 may be performed. In particular, when three mainline ads, for example, are shown, the parameters of interest are p_{q,1,3}, p_{q,2,3} and p_{q,3,3}. When one mainline ad is shown, the parameter of interest is p_{q,1,1}. To determine the values of these parameters the following ratios may be examined:

e_{—}q=p_{—}{q,1,1}/p_{—}{q,1,3}, which is the ratio of the CTR of a top ad with exclusivity and without exclusivity (2),

b2_{—}q=p_{—}{q,2,3}/p_{—}{q,1,3} (3),

b3_{—}q=p_{—}{q,3,3}/p_{—}{q,1,3} (4).

From the quantities e_q, b2_q, and b3_q, the p_{q,i,m} position bias adjustment values may be determined with three ads and with one exclusive ad. This is because the value of e_q is strongly correlated to the following search result parameters:
c_{q,1}: CTR of algo1 position for the query. The parameter “algo1” is the search result in the first search position. The parameter e_q tends to be higher for queries that have a low CTR at algo1.
f_q: Query frequency. The parameter e_q tends to be higher for queries that are issued more frequently (e.g., “head queries”). Lower frequency queries may be considered “tail queries.”

From the above search result parameters, c_{q,1} and f_q may be used to obtain an estimate for the ad parameter e_q by applying a linear regression at 504 to estimate the value:

e_q=alpha*c_{—}{1,q}+beta*f_{—}q+gamma (5).

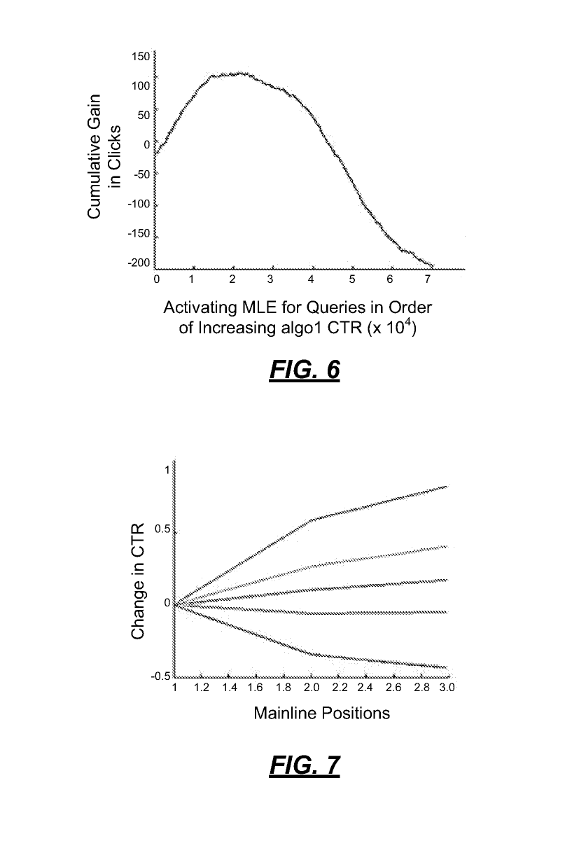

The click logs may be used to obtain the optimal values of the regression coefficients alpha, beta and gamma. Because the relationship is approximately linear, the values alpha, beta and gamma may be determined by sampling the click logs to determine how a rate of change of CTR of the algo1 position and query frequency affect the observed CTR of the top ad with and without exclusivity. Graphical illustrations of aspects of the observed CTR are shown in FIGS. 6 and 7. Alternatively, a linear regression may be performed on the logs of e_q, c_{—{q,}1}, and f_q.

The values of b2_q and b3_q are negatively correlated to s_q, which is a position bias value in the search results. At 508, the position bias value is determined. The value “s_q” is the drop in the CTR when a particular search result moves from the algo1 position to lower algo positions. One way to measure s_q is to examine the CTR of the search result positions as a distribution and taking the entropy of the distribution. The distribution may comprise a frequency distribution of clicks at each of the search result positions (algo1 and the lower positions) for the particular search result. The entropy of the distribution will determine a concentration of the click through rate data for the search result at the various positions. If the CTR is concentrated in the first position (i.e., a high position bias), the value of s_q is small as the entropy of the click results is relatively low; otherwise, it is large (i.e., a low position bias) as the entropy of the click results is relative high.

At 508, the estimate of the position bias adjustment factor is determined. This may be determined from e_q, b2_q, and b3_q which is used, as noted above, to determine the p_{q,i,m} position adjustment values. The flow then continues at 406.

Referring again to FIG. 4, at 406, the position bias adjustment factor is applied to determine if the estimated CTR will increase. For example, if the estimated CTR will increase in view of the determined position bias adjustment factor, then at 408, mainline exclusivity may be activated for the particular query. As such, a single mainline ad is presented.

FIGS. 6 and 7 illustrate various plots showing the gain in click through rate when mainline exclusivity is activated for a particular query. FIG. 6 illustrates the effects of activating MLE when algo1 CTR (c_{q,1}) is low. For queries that are sorted by algo1 CTR, MLE is turned on for those queries below a threshold. FIG. 6 illustrates that there is an increasing gain in the CTR after turning on MLE until a threshold is reached, thereafter the gain drops. The threshold is about 0.23 in this example. As such, queries with algo1 CTR<0.23 appear to benefit from MLE.

FIG. 7 illustrates the effect of the number of mainline ads on the CTR of the top ad. The median change in CTR with increasing ML count (i.e., a number of mainline ads) for five different query buckets is shown. The buckets were obtained by sorting the queries by the “slope” of the curves. In this example, going from ML count of one to three increases the CTR of top ad for many queries, but also decreases it for many queries. In the aggregate, there is a slight increase in going from ML count one to ML count three, where the median change in CTR of top ML ad is an increase of about 17% in the example.

In some implementations, there may be a gain from moving from one mainline ad to more mainline ads, such as three mainline ads, five mainline ads, etc. For example, a function using c_{q,1} and CTR_{q,1,3} may predict when e_q for three mainline ads would be greater than 1. The following function combines these two inputs and provides a prediction for e_q being more than 1:

(c_{—}{q,1}<0.23) OR (CTR_{—}{q,1,3}<0.2) (6),

where 0.23 and 0.2 are CTR thresholds.

FIG. 8 shows an exemplary computing environment in which example embodiments and aspects may be implemented. The computing system environment is only one example of a suitable computing environment and is not intended to suggest any limitation as to the scope of use or functionality.

Numerous other general purpose or special purpose computing system environments or configurations may be used. Examples of well known computing systems, environments, and/or configurations that may be suitable for use include, but are not limited to, personal computers, server computers, handheld or laptop devices, multiprocessor systems, microprocessor-based systems, network personal computers, minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 8, an exemplary system for implementing aspects described herein includes a computing device, such as computing device 800. In its most basic configuration, computing device 800 typically includes at least one processing unit 802 and memory 804. Depending on the exact configuration and type of computing device, memory 804 may be volatile (such as random access memory (RAM)), non-volatile (such as read-only memory (ROM), flash memory, etc.), or some combination of the two. This most basic configuration is illustrated in FIG. 8 by dashed line 806.

Computing device 800 may have additional features/functionality. For example, computing device 800 may include additional storage (removable and/or non-removable) including, but not limited to, magnetic or optical disks or tape. Such additional storage is illustrated in FIG. 8 by removable storage 808 and non-removable storage 810.

Computing device 800 typically includes a variety of computer readable media. Computer readable media can be any available media that can be accessed by device 800 and includes both volatile and non-volatile media, removable and non-removable media.

Computer storage media include volatile and non-volatile, and removable and non-removable media implemented in any method or technology for storage of information such as computer readable instructions, data structures, program modules or other data. Memory 804, removable storage 808, and non-removable storage 810 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 800. Any such computer storage media may be part of computing device 800.

Computing device 800 may contain communications connection(s) 812 that allow the device to communicate with other devices. Computing device 800 may also have input device(s) 814 such as a keyboard, mouse, pen, voice input device, touch input device, etc. Output device(s) 816 such as a display, speakers, printer, etc. may also be included. All these devices are well known in the art and need not be discussed at length here.

It should be understood that the various techniques described herein may be implemented in connection with hardware or software or, where appropriate, with a combination of both. Thus, the methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be effected across a plurality of devices. Such devices might include personal computers, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method, comprising:
determining, at an ad placement subsystem, a first placement of ads on a search results page associated with search results determined in response to a query;
determining an adjustment factor based on parameters associated with the search results ascertained from a click log database; and
applying the adjustment factor to the first placement of ads to determine if a second placement of ads results in a higher estimated click through rate for a particular ad served as a result of the query.

2. The method of claim 1, further comprising determining the adjustment factor using an estimate based on click data associated with links ranked by the search results.

3. The method of claim 2, further comprising determining a ratio of a click through rate of a top ad with exclusivity and the top ad without exclusivity by apply a linear regression to the click through rate of a first result position and a query frequency.

4. The method of claim 3, further comprising determining a position bias by using the click through rate of ad positions as a distribution and determining an entropy of the distribution.

5. The method of claim 4, further comprising using the ratio and the position bias to determine the adjustment factor.

6. The method of claim 3, further comprising applying the linear regression as alpha*(click through rate at the first result position)+beta*(query frequency)+gamma, wherein the value of alpha, beta and gamma are determined from click logs.

7. The method of claim 2, further comprising:
determining first parameters associated with plural mainline ads, each of the first parameters being associated with a respective one of the plural mainline ads;
determining a second parameter associated with one mainline ad;
determining a first ratio of the second parameter to a first of the first parameters; and
determining a second ratio of a second of the first parameters and the first of the first parameters; and
determining a third ratio of a third of the first parameters and the first of the first parameters.

8. The method of claim 7, further comprising determining the adjustment factor in accordance with the first ratio, the second ratio and the third ratio.

9. The method of claim 1, further comprising determining a threshold at which the adjustment factor results in a lower estimated click through rate.

10. The method of claim 1, wherein the second placement of ads is a mainline exclusivity of the particular ad.

11. The method of claim 1, wherein the second placement of ads comprises a greater number of ads than a number of ads in the first placement of ads.

12. A computer-implemented method, comprising:
determining, at a search engine, search results that satisfy a query, the search results being formatted into a search results page;
determining, at an ad placement subsystem, a placement of ads within the search results page;
determining a click through rate of the ads in the search results page;
determining an adjustment factor based on parameters associated with the search results, the adjustment factor being applied to an ad to determine an estimated click through rate of the ad in a mainline position on the search results page; and
providing the ad in the results page from the search engine with mainline exclusivity if the applying the estimated click through rate determined in accordance with the adjustment factor is higher that the click through rate.

13. The method of claim 12, wherein a parameter associated with the search results is click data associated with the search results.

14. The method of claim 13, further comprising determining a ratio of a click through rate of a top ad with exclusivity and the top ad without exclusivity by apply a linear regression to the click through rate of a first result position and a query frequency.

15. The method of claim 14, further comprising determining a position bias by using the click through rate in ad positions as a distribution and determining an entropy of the distribution.

16. The method of claim 15, further comprising using the ratio and the position bias to determine the adjustment factor.

17. A computer-readable medium coupled to a processor and having instructions stored thereon, which, when executed by the processor, causes the processor to perform operations comprising:
formatting a search results page having a mainline ad position and an ordered list of search results responsive to a received query;
accessing a click log to determine a click through rate of a first search result in the ordered list of search results;
determining a click through rate of ads to be presented on search results page;
determining an adjustment factor based on the click through rate of the first search result and a frequency of the received query, the adjustment factor being applied to the click through rate of an ad to determine an estimated click through rate of the ad when the ad is presented exclusively in the mainline position; and
reformatting the search results page such that the ad is presented exclusively in the mainline position if the applying the estimated click through rate determined in accordance with the adjustment factor is higher that the click through rate.

18. The computer-readable medium of claim 17, further comprising instructions for determining the adjustment factor by applying a linear regression to click through rate of the first result position and the query frequency to determine a value of a ratio.

19. The computer-readable medium of claim 18, further comprising instructions for determining a position bias by using the click through rate of the first search result when presented in other positions in the ordered list of search results.

20. The computer-readable medium of claim 19, further comprising instructions for using the value of the ratio and the position bias to determine the adjustment factor.
